(19) United States
(12) Patent Application Publication
(10) Pub. No.: US 2013/0060642 A1
(43) Pub. Date: Mar. 7, 2013

(54) Smart Electronic Roadside Billboard

(71) Applicant: Eyal Shlomot, Long Beach, CA (US)

(72) Inventor: Eyal Shlomot, Long Beach, CA (US)

(21) Appl. No.: 13/586,016

(22) Filed: Aug. 15, 2012

Related U.S. Application Data
(60) Provisional application No. 61/573,205, filed on Sep. 1, 2011.

(51) Int. Cl. G06Q 30/02

(52) U.S. Cl. 705/14.66

(57) ABSTRACT

There is provided a method for selecting an advertisement to be displayed on a smart electronic roadside electronic billboard. The method comprises capturing visual information of cars traveling on a road and using the visual information to extract identification characteristics about the cars, passengers in the cars, as well as items or pets that might be in the cars. The method further comprises using the identification characteristics to select an advertisement to be displayed on the smart electronic roadside electronic billboard, such that the selected advertisement maximizes the advertisement value. The method may further comprises using other general factors and timing considerations in selecting and displaying an advertisement. The method may be implemented by an apparatus comprising of at least one camera that captures the visual information and at least one control unit that extracts the identification characteristics from the visual information and use the identification characteristics to select the advertisement to be displayed on the smart electronic roadside electronic billboard.

This application claims the benefit of U.S. Provisional Application No. 61/573,205 filed Aug. 17, 2011

### BACKGROUND OF THE INVENTION

1. Field of the Invention

The present invention relates to smart control of electronic roadside billboards and is targeted to maximize the value of advertisements presented on electronic roadside billboards by choosing the best advertisement for the population viewing the advertisements.

2. Background Art

Roadside billboard are extensively used for effective advertisement all over the world. Traditional roadside billboards are placed at strategic viewing locations and display large pictorial advertisements, printed or painted on paper, cloth, wood, plastic or any other material that is held by a supporting frame. Recently new type of billboards, electronic roadside billboards, are extensively installed, either as a replacement of existing traditional billboards or as newly placed billboards.

Instead of printed or painted advertisements, electronic roadside billboards display images, graphics or videos on light-emitting electronic displays. Construction and placement of electronic roadside billboards is considerably more expensive than the construction and placement of traditional roadside billboards. However, electronic roadside billboards can provide significant advertisement advantages and, assuming a reliable long-term operation, might be cheaper to operate in the long run.

A first advantage in using electronic roadside billboards is the simplicity and speed of changing or updating an advertisement. Change of advertisement in traditional roadside billboards requires the physical painting or printing of the advertisement material and the manual labor of removing an old advertisement and replacing it with the newly prepared advertisement. On the other hand, advertisements on electronic roadside billboards can be changed or updated simply and rapidly by electronically sending the new advertisement image, graphics or video to the electronic roadside billboards.

A second advantage of using electronic roadside billboards is the ability to display dynamic advertisements, including rapidly changing images, moving graphics or video clips. (It should be noted that in many jurisdictions displaying of videos and even rapidly changing images or moving graphics is prohibited by law, to avoid drivers distraction and the risk of traffic accidents.)

Targeted advertisement, which addresses specific and relevant viewing population, is a key for modern and successful advertisement. Electronic roadside billboards allow easy and frequent changes of advertisements, but they cannot be used for targeted advertisement since the viewing population of the displayed advertisements is unknown and therefore it is impossible to select the best advertisement for the viewing population. (The viewing population might only be anticipated by some general factors, such as the billboard location, hour of the day, local weather or local events.) Therefore, there is a need for an approach to provide more accurate information about the viewing population that is traveling by the electronic roadside billboards and therefore is likely to notice and be influenced by the displayed advertisements. This information may allow selecting and displaying, at any moment in time, the most suitable advertisement for the particular viewing population and therefore to maximize the effective value of the displayed advertisements.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 illustrates a schematic diagram of a conventional roadside billboard.

FIG. 2 illustrates a schematic diagram of a smart electronic roadside billboard.

FIG. 3 illustrates a general flowchart of the operations of a smart electronic roadside billboard.

### DETAILED DESCRIPTION OF THE INVENTION

The present invention is directed to a smart electronic roadside billboard system, which captures and analyzes visual information (such as pictures or videos) to provide information on a viewing population of travelers that pass through an effective viewing area for an electronic roadside billboard, and that selects an advertisement that is most suitable and effective (in some sense) for that viewing population. Although the invention is described with respect to specific embodiments, the principles of the invention can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention which use the principles of the present invention are not specifically described in the present application and are not specifically illustrated by the present drawings. It should be borne in mind that, unless noted otherwise, like or corresponding elements among the figures may be indicated by like or corresponding reference numerals.

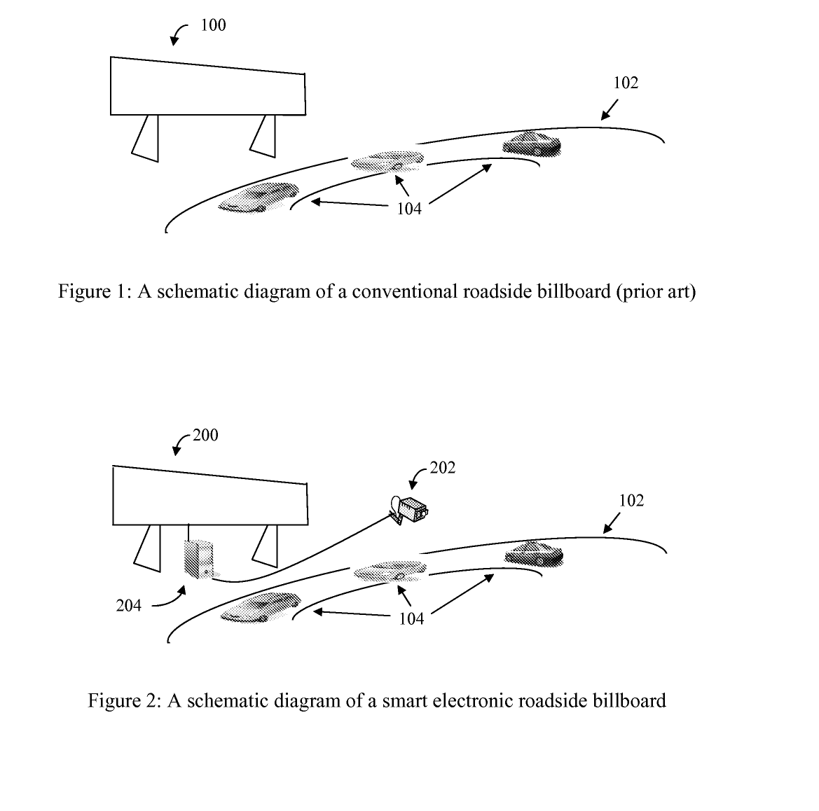

FIG. 1 shows a schematic diagram of a conventional (or electronic) roadside billboard 100. The billboard is commonly placed near a curve in the road 102, which provides the best viewing conditions (the effective viewing area) for the people that travel in the cars 104.

FIG. 2 shows a schematic diagram of a smart electronic roadside billboard 200. Similar to the conventional roadside billboard 100, it is also commonly placed near a curve in the road 102, which provides the best viewing conditions for the people that travel in the cars 104. However, the smart electronic roadside billboard includes a camera 202 and a control unit 204. The camera can be a video camera or a still camera. The camera captures visual information such as pictures or videos of the cars advancing toward the smart electronic roadside billboard and provides the pictures, videos, or other information to the control unit. In the most likely configuration the camera may be placed at some distance before the smart electronic road billboard, which means that it may capture pictures or videos of cars that will arrive later to the effective viewing area of the smart electronic road billboard. In another possible configuration several cameras may be placed at different locations and angles to capture more than one picture or one video of the passing cars. The visual information will consist of all pictures and videos captured by all cameras. Moreover, one or more cameras may operate at an electromagnetic spectrum which is not visible by human, such as infrared of ultraviolet wavelengths, wherein the visual information will also consist on the pictures or videos obtained by cameras using such out-of-visible-light spectrum.

The visual information, which is the digital representation of the pictures or videos captured by the camera or the multiple cameras, is processed by control unit 204. The depiction of the control unit 204 in FIG. 2 is provided only as an example. In other configurations the processing may by distributed over several processing units or modules in different physical locations, including the camera-apparatuses themselves, a processing unit or several connected processing units dedicated to the smart electronic roadside billboard, or other processing units, local or remote, each carry part of the processing. The goal of the processing is to analyze and extract identification characteristics about the passing cars, about the passengers, items or pets traveling in the cars or any other useful information that may have a value in making an advertisement decision or that may assist in the operation of the smart electronic road billboard.

The identification characteristics for any car may include the make (manufacturing company) of the car (e.g., Honda, Toyota, Ford, etc.), the model of the car (e.g., Accord, Prius, Focus, etc.), the model-year of the car, the color of the car, the mechanical and exterior condition of the car, the traveling speed or the position of the car on the road (such as lanes, relative positions and distances from other cars), or any other identification characteristics about the car that may have a value in making an advertisement decision. In jurisdictions where permitted by law, the identification characteristics may include the license plate registration number of the car or any other information that identifies the car. The identification characteristics may include the number of passengers in the car, the age of any passenger in the cars, the gender of any passenger in the cars, the ethnic origin of any passenger in the car, or any other information about the passengers in the car that can have a value in making an advertisement decision. (A passenger is a person in the car that is the driver of the car or any other person in the car in addition to the driver.) The identification characteristics may also include the presence of items in the car such as child seats, sport gear or technical gadgets (e.g., smartphone, GPS unit, music player, tablet, etc.), or any other information about any item in the car that may have a value in making an advertisement decision. The identification characteristics may include the presence of any pet in the cars and the species and breed of any pet (a pet traveling in a car will most likely be a dog), or any other information about any pet in the car that can have a value in making an advertisement decision.

The process of extracting the identification characteristics from the visual information is commonly called scene analysis. Scene analysis is a well known concept of using analytically and heuristically-formed algorithms to extract various characteristics from the visual information. It can use many concepts and multiple processing tools in numerous stages. For example, during day light, the car make, model and model-year may be identified by matching any car structural features contained in the visual information (e.g., shapes of windows, doors, front grills, wheels, roofs or trunks, or any other structural element of any car) to a pre-stored database of car structural features. At night time, on the other hand, any car identification characteristics may be based on matching any light emitting elements contained in the visual information (e.g., head, tail, break, signaling or other lights) to a pre-stored database of car light emitting elements (such as relative positions, shape, or spectral attributes). In another example, during day time the identification characteristics of a passenger in the car such as age, gender or ethnic background may be extracted by examining body and facial parameters, which may consist of estimated height and weight, hair style and color, skin texture and tone, lips structuring and coloring, as well as by examining the clothes the passengers are wearing. During night time the number of passengers in the cars and other identification characteristics of any passenger in any car may be estimated using infrared imaging. Items in the car, such as child seats, sport gear or technical gadgets or any other items in any car may be identified by matching their structural features to a pre-stored database of structural features of such items. In yet another example, any pet traveling in any car may be identified and its species and breed may be determined by analyzing the pet size, shape, color or facial features.

The identification characteristics are collected and analyzed to make a decision on which advertisement to display at each time, with the goal of choosing the best advertisements to maximize the advertisement value to the viewing population. The advertisements to be displayed may be stored locally or in a remote location for transmission to the smart electronic roadside billboard via a communication link (not shown in FIG. 2), based on the decision made by the local processing unit or units, or by making the advertisement decision at a remote location.

The decision on which advertisement to display may be made using several criteria. One criteria can be a value of a parameter. For example, upon finding a significantly higher ratio of female passengers to male passengers (or vice verse) traveling in the cars approaching the smart electronic roadside billboard, an advertisement that has a higher value for female viewers may be selected to be displayed on the smart electronic roadside billboard (or vice versa, if there are more male passengers than female passengers). In another example, the choice of the advertisement may be based on several parameters, which together are used to make a decision on displaying a specific advertisement on the smart electronic roadside billboard. For example, upon the detection of several luxury cars with children traveling in these luxury cars, the selected advertisements might be for luxury toys, children vacations or other advertisements targeted for high-income families with children.

The decision may be made using any of the identification characteristics, and may be made based on the statistical properties of the identification characteristics, such as averages, maxima, outliers, or any other function derived from the identification characteristics. The decision may be based on a pre-set criteria, which may be set according to advertisement and marketing researches, in order to display an advertisement that is considered to have the highest marketing value for the viewing population traveling in the cars as they approach the smart electronic roadside billboard. Moreover, the decision of which advertisement to display at each time can also consider some other general factors, which may include the location of the electronic billboard, hour of the day, local (or regional) weather conditions, or particular promotional and sale events.

It is important to note that it will be sufficient to extract only some of the identification characteristics for some of the cars or some of the passengers, items or pets traveling in the cars for a successful implementation of this invention. Based on the positions of the cameras, the light conditions, the weather conditions or any other factor that might limit the capturing or the analysis of the visual information, it is possible that only some of the identification characteristics of only some of the cars, as well as of only some of the passengers, items or pets in the cars, will be successfully extracted. Of course, the decision on which advertisement to use will likely improve as the system is able to obtain more of the identification characteristics of the cars and the passengers, items or pets in the cars.

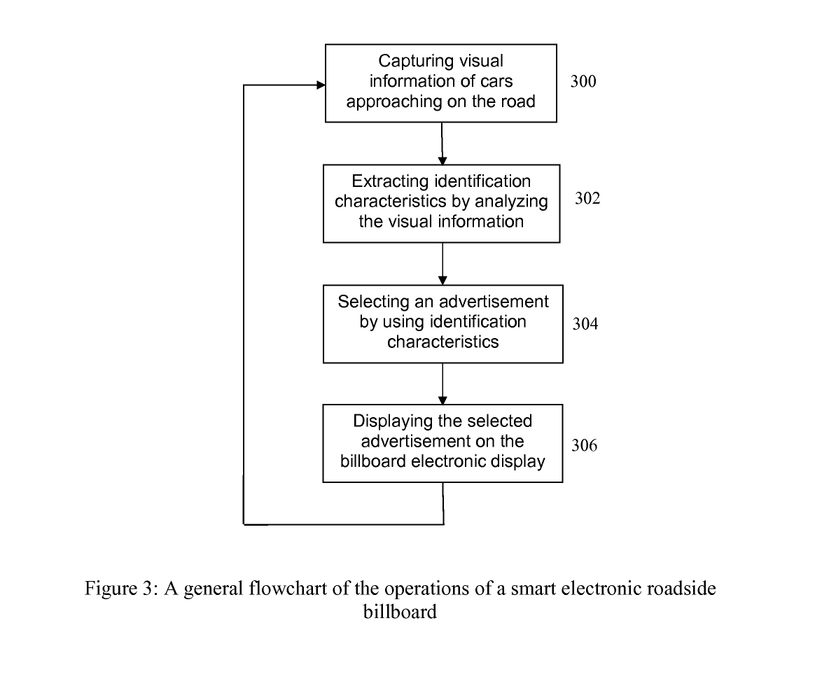

FIG. 3 provides a general flowchart of the operations of a smart electronic roadside billboard. At step 300, the visual information of the cars approaching the smart electronic roadside billboard is captured. The visual information may be captured by a single camera or by several cameras, which may be still cameras or video cameras. The visual information may be in wavelengths visible by a human eye, or in wavelengths invisible to a human eye, such as infrared or ultraviolet lights. The visual information is the digital representation of the pictures and/or the videos captured by the cameras. At step 302 identification characteristics are extracted from visual information, which may be done by a variety of scene analysis algorithms, The scene analysis results in identification characteristics for the cars and the passengers traveling in the cars, as well as items and pets that might be in the cars. The identification characteristics are then used in step 304 to make a decision on the advertisement that will be displayed on the smart electronic roadside billboard. The advertisement is selected to maximize the advertisement value for the viewing population that will be traveling through the effective viewing area when the advertisement is displayed. The selected advertisement is then displayed on the electronic display of the smart electronic roadside billboard at step 306.

The processing is repeated for the next group of cars that will be approaching the effective viewing area and results in the selection of a new advertisement for this next group. The time-period of showing each advertisement may depend on several factors. One factor may be the size of the effective viewing area, which is the area where the viewing population can effectively view the smart electronic roadside billboard. For example, a billboard on a curve at the end of long straight stretch of a road will have a large effective viewing area and therefore each advertisement can be displayed longer than for a billboard with a smaller effective viewing area. In another example, a billboard at an intersection may synchronize the change of advertisements with the traffic lights in the intersection. Notably, another critical factor for the rate of change for advertisements might be the legal restrictions for such rate of change for electronic billboards in specific jurisdictions.

The processing in FIG. 3 is depicted as a sequential processing, but it may also be done in parallel by different processing modules. For example, at the same time that the electronic display is displaying the advertisement for one group of cars that are currently traveling through the effective viewing area, the control unit may be completing the extracting of the identification parameters and the selecting of the advertisement for the next group of cars, while the cameras may be capturing the visual information for a further next group of cars.

1. A method for operating a smart electronic roadside billboard, the method comprises:
capturing visual information of at least one car in a plurality of cars;
extracting at least one identification characteristic in a plurality of identification characteristics from the visual information of the at least one car in the plurality of cars;
selecting an advertisement from a plurality of advertisements using the at least one identification characteristics; and
displaying the selected advertisement on the smart electronic roadside billboard.

2. The method of claim 1, wherein the plurality of identification characteristics consists of at least one of a car make, a car model, a car model-year, a car color, a car mechanical and exterior condition, a car speed, a car position on a road, a car license plate registration number, a number of passengers in a car, a passenger gender, a passenger age, a passenger ethnic origin, a child seat presence, a sport gear presence and type, a technical gadget presence and type, and a pet presence and species and breed.

3. The method of claim 1, wherein the at least one identification characteristic is extracted from the visual information by scene analysis.

4. The method of claim 1, wherein the selecting an advertisement from a plurality of advertisements further comprises maximizing an advertisement value.

5. The method of claim 1, wherein the selecting an advertisement from a plurality of advertisements further uses a condition from a plurality of general factors, wherein the plurality of general factors consists of at least one of a location of the smart electronic roadside billboard, an hour of the day, a weather condition, and a promotional and sale event.

6. The method of claim 1, further comprising changing the selected advertisement based on at least one of a size of an effective viewing area and an event of traffic light change.

7. A smart electronic roadside billboard, comprising:
a camera configured to capture visual information of at least one car in a plurality of cars;
a control unit configured to extract at least one identification characteristic from a plurality of identification characteristics using the visual information of the at least one car in the plurality of cars, wherein the control unit is further configured to select an advertisement from a plurality of advertisements using the at least one identification characteristics; and
an electronic display configured to display the selected advertisement on the smart electronic roadside billboard.

8. The smart electronic roadside billboard of claim 7, wherein the plurality of identification characteristics consists of at least one of a car make, a car model, a car model-year, a car color, a car mechanical and exterior condition, a car speed, a car position on a road, a car license plate registration number, a number of passengers in a car, a passenger gender, a passenger age, a passenger ethnic origin, a child seat presence, a sport gear presence and type, a technical gadget presence and type, and a pet presence and species and breed.

9. The method of claim 7, wherein the control unit is further configured to perform scene analysis to extract the at least one identification characteristic from the visual information.

10. The smart electronic roadside billboard of claim 7, wherein the control unit is further configured to select an advertisement by maximizing an advertisement value for a viewing population.

11. The smart electronic roadside billboard of claim 7, wherein the control unit is further configured to select an advertisement from a plurality of advertisements by using a condition from a plurality of general factors, wherein the plurality of general factors consists of at least one of a location of the electronic billboard, an hour of the day, a weather condition, and a promotional and sale event.

12. The smart electronic roadside billboard of claim 7, wherein the control unit is further configured to change the selected advertisement based on at least one of a size of an effective viewing area and an event of traffic light change.
